(19) United States
(12) Patent Application Publication
(10) Pub. No.: US 2015/0213634 A1
(43) Pub. Date: Jul. 30, 2015

(54) METHOD AND SYSTEM OF MODIFYING TEXT CONTENT PRESENTATION SETTINGS AS DETERMINED BY USER STATES BASED ON USER EYE METRIC DATA

(71) Applicants: Amit V. Karmarkar, Palo Alto, CA (US); Richard R. Peters, Mill Valley, CA (US)

(72) Inventors: Amit V. Karmarkar, Palo Alto, CA (US); Richard R. Peters, Mill Valley, CA (US)

(21) Appl. No.: 14/166,753

(22) Filed: Jan. 28, 2014

(51) Int. Cl. G06T 11/60; G06K 9/00; G06T 11/00

(52) U.S. Cl. CPC G06T 11/60; G06T 11/001; G06K 9/0061; G08B 3/10

(57) ABSTRACT

In one exemplary embodiment, a method includes the step of obtaining, with an eye-tracking system, one or more user eye metrics, while the user is reading a text content. A step can include determining that the one or more user eye metrics indicate a user mental fatigue state based on the one or more user eye metrics. A step can include modifying an attribute of the text content. One or more user eye metrics that indicate the user mental fatigue state comprise a decrease in saccadic peak velocity during a task. The one or more user eye metrics that indicate the user mental fatigue state comprises a regression analysis of a relationship of the saccadic peak velocity, a user blink attribute, and a measurement of an ocular instability of the user.

### CROSS-REFERENCE TO RELATED APPLICATIONS

This application claims priority to U.S. Provisional Application No. 61/757,682, filed Jan. 28, 2013. These applications are hereby incorporated by reference in their entirety.

### BACKGROUND OF THE INVENTION

1. Field

This application relates generally to human-computer interactions, and more specifically to a system and method for modifying text content presentation settings as determined by user states based on user eye metric data.

2. Related Art

Eye-tracking systems can be included in many of today's electronic devices such as personal computers, laptops, tablet computers, user-wearable goggles, smart phones, digital billboards, game consoles, and the like. An eye-tracking system may monitor a user as the user engages a digital document (e.g. a static webpage, a dynamic webpage, an e-reader page, a MMS message, a digital billboard content, an augmented reality viewer that can include computer-generated sensory input such as sound, video, graphics, GPS data, a digital photograph or video viewer, and the like). The eye-tracking data (e.g. can include information about a user's eye movement such as regressions, fixation metrics such as time to first fixation and fixation duration, scan paths, gaze plots, fixation patterns, saccade patterns, pupil sizes, blinking patterns and the like) may indicate a coordinate location (such as an x, y coordinate with a time stamp) of a particular visual element of the digital document—such as a particular word in a text field or figure in an image. For instance, a person reading an e-book text may quickly read over some words while pausing at others. Quick eye movements may then be associated with the words the person was reading. When the eyes simultaneously pause and focus on a certain word for a longer duration than other words, this response may then be associated with the particular word the person was reading. This association of a particular word and eye-tracking data of certain parameters may then be analyzed. In this way, eye-tracking data can indicate certain states within the user that are related to the elements of the digital document that correspond to particular eye movement patterns.

Eye-tracking data can be collected from a variety of devices and eye-tracking systems. Computing devices frequently include high-resolution cameras capable of monitoring a person's facial expressions and/or eye movements while viewing or experiencing media. Cellular telephones now include high-resolution user-facing cameras, proximity sensors, accelerometers, and gyroscopes and these ‘smart phones’ have the capacity to expand the hardware to include additional sensors. Accordingly, video-based eye-tracking systems can be integrated into existing electronic devices. Thus, a method and system are desired for modifying text content presentation settings as determined by user states based on user eye metric data.

### BRIEF SUMMARY OF THE INVENTION

In one exemplary embodiment, a method includes the step of obtaining, with an eye-tracking system, one or more user eye metrics, while the user is reading a text content. A step can include determining that the one or more user eye metrics indicate a user mental fatigue state based on the one or more user eye metrics. A step can include modifying an attribute of the text content.

Optionally, the one or more user eye metrics that indicate the user mental fatigue state comprise a decrease in saccadic peak velocity during a task. The one or more user eye metrics that indicate the user mental fatigue state can be calculated with a regression analysis of a relationship of the saccadic peak velocity, a user blink attribute, and a measurement of an ocular instability of the user. The value calculated from the regression analysis using the relationship of the saccadic peak velocity, a user blink attribute, and a measurement of the ocular instability of the user can decline below a specified threshold value. Modifying an attribute of the text content can further include repeating a display of the text content to the user.

### BRIEF DESCRIPTION OF THE DRAWINGS

The present application can be best understood by reference to the following description taken in conjunction with the accompanying figures, in which like parts may be referred to by like numerals.

FIG. 1 depicts, in block diagram format, a process 100 of determining various computer states based on user mental states as derived from eye-tracking data, according to some embodiments.

FIG. 2 illustrates one example of obtaining eye-tracking data from a user viewing a digital document.

FIGS. 3A-B depict an example of setting reading material level based on user eye-tracking data, according to some embodiments.

FIG. 4 depicts an example process for setting a state of a computing device based on a mental attribute of a user (e.g. mental fatigue) as determined from eye-tracking data, according to some embodiments.

FIG. 5 depicts an example process of determining an insurance rate for a particular activity based on user eye-tracking data, according to some embodiments.

FIG. 6 depicts an exemplary computing system that can be configured to perform any one of the processes provided herein.

FIG. 7 illustrates a side view of augmented-reality glasses that can be used to implement some embodiments.

FIG. 8 is a block diagram of a sample computing environment that can be utilized to implement various embodiments.

FIG. 9 illustrates an example plot showing the relationship between two or more eye metrics used to determine a user mental fatigue state, according to some embodiments.

FIG. 10 depicts, in block diagram format, an example of a text modification module, according to some embodiments.

The Figures described above are a representative set of sample screens, and are not an exhaustive set of screens embodying the invention.

### DETAILED DESCRIPTION

Disclosed are a system, method, and article of modifying text content presentation settings as determined by user states based on user eye metric data. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

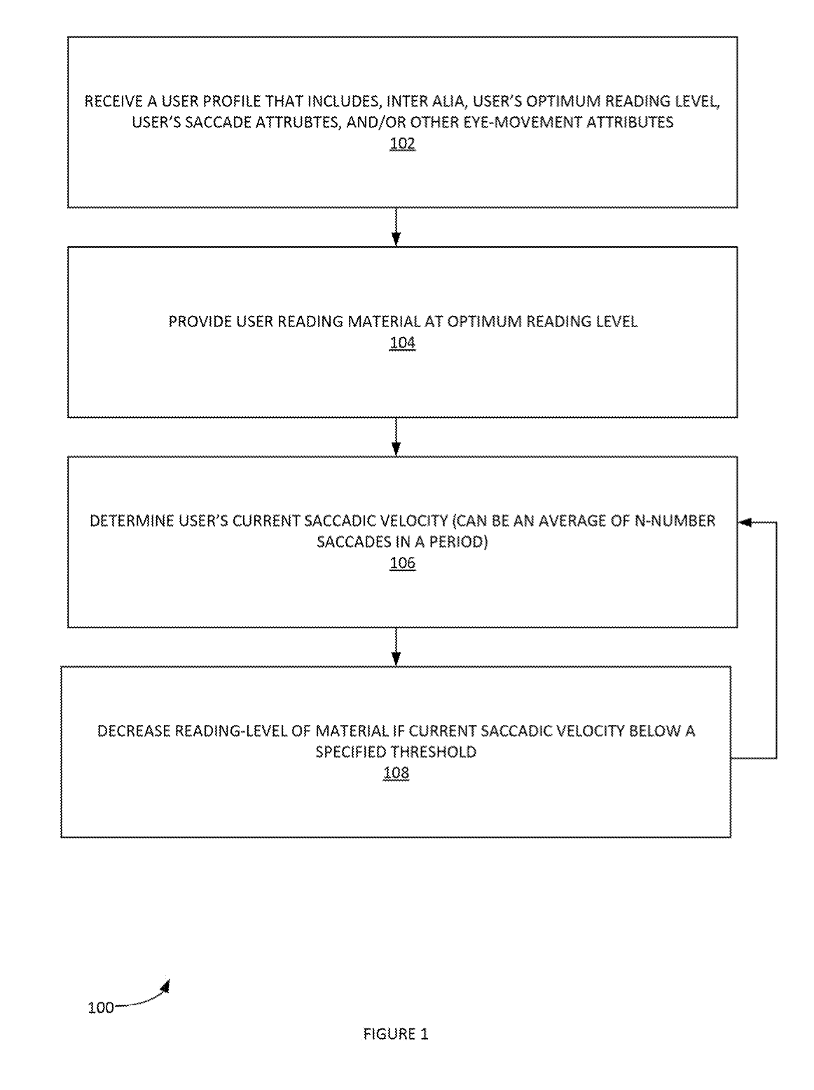

FIG. 1 depicts, in block diagram format, a process 100 of determining various computer states based on user mental states as derived from eye-tracking data according to some embodiments.

As used herein, a saccadic eye movement (a ‘saccade’ as used herein) can be rapid, steplike movements of the eye that are produced as a human user scans a visual element such as text, images, physical objects and the like. Saccades may also reflect visual attention of the user and thus indicate user attributes (e.g. interest, comprehension difficulty, etc.). Some saccades can be volitional while others (e.g. microsaccades, reflexive saccades) can be involuntary. A saccade may be initiated cortically by the frontal eye fields (FEF), or subcortically by the superior colliculus. A saccade may serve as a mechanism for fixation, rapid eye movement, and/or the fast phase of optokinetic nystagmus. Saccadic attributes can vary as a function of a user's mental fatigue levels. For example, the spatial endpoints of saccades may tend to become more variable with fatigue (see Bahill, Brockenbrough, & Troost, 1981; Bahill & Stark, 1975a). Variability in (average) saccadic overshoot/undershoot (including dynamic overshoot and/or undershoot and/or glissadic overshoot and/or undershoot) can be measured and stored in a database. These attributes can be observed and compared against a set of substantially optimal saccadic attributes for a user. It is noted that environmental conditions (e.g. environmental light values, user pathologies, user's drug/medicine intake, attributes of a viewed visual object, and the like) can be used to weight saccadic attributes where it is known that the environmental condition affects the respective saccadic attribute (e.g. the stereotyped relationship between a saccade's distance and duration can be influenced by ambient lighting).

If a deviation of saccadic attributes beyond a specified threshold is observed in a user, then a system can be modulated to compensate for a user's fatigue level. For example, if the user is reading an e-book, digital flash cards and/or a web page—the reading level of the material can be modulate based on the level of fatigue indicated by the substantially current saccadic attributes.

In step 102 of process 100, a user profile is received. The user profile can include, inter alia, a user's optimum reading level (e.g. can include factors that affect readability of text, difficulty of text terms, specialization of content of text, student grade reading levels, vocabulary content and the like), a user's historical saccade (and/or other eye-tracking data) attributes (e.g. historical saccadic velocities (e.g. based on analysis of the slope and/or plot of the saccadic peak velocity-magnitude relationship) when a user is not mentally fatigued, historical pupil dilation patterns when a user is not mentally fatigue, historical user saccadic velocities when a user is mentally fatigued, etc.), and/or other eye movement attributes. The various parameters of each sensed saccade can be measured and determined such as peak and mean saccadic velocity, magnitude and/or duration of saccade. Equivalent parameters can be compared as a function of time. Data transformation can be implemented on these parameters (e.g. logarithmic transformations, square root transformation, multiplicative inverse (reciprocal) transformation, Variance-stabilizing transformations, transforming to a uniform distribution, etc.). The fit of the transformed data can be compared with pre-defined parameters for determine a user's mental fatigue state. In one example, these pre-defined parameters can be determined using historical eye movement attributes that can be obtained during a training session, during past uses of an eye-tracking device and the like. A user can input information about historical user states to associate with various eye-tracking sessions. For example, a user's eye tracking data can be obtained for a period of time and the user can input “not mentally fatigued”. In another example, a user can experience mental fatigue during an eye-tracking session and input “mentally fatigued”. In this way, a system that performs process 100 can obtain a set of baseline eye movement attributes for a particular user. It is noted that anthropological norms and/or averages can also be used to determine a user's current mental state from eye-movement data as well. For example, a user's substantially contemporary saccadic velocity (e.g. assuming processing and networking latencies in system measuring saccadic velocity) can be compared with past data obtained for past studies of the relationship between saccadic velocity and mental fatigue in order to determine a user's current mental fatigue state. A user's demographic profile (e.g. age, gender and the like) can also be utilized to further refine the relationship between anthropological norms and/or averages for saccadic velocities and mental fatigue. A user profile can also include a user's reading level. For example, a user may have been tested and a grade reading level determined. This information can be provided to the system. In one example, saccadic value when a user began a session (e.g. task, work shift, etc.) can be compared with later saccadic values. A variation (e.g. decrease in average saccadic velocity, decrease in saccadic peak velocity-magnitude relationship, and the like) in these values can be used to indicate mental fatigue. In one example, a decrease in a saccadic metric and an increase in blink rate for a session can be used to indicate mental fatigue. In another example, an increase in user ‘look aways’ from the reading material and/or regressions to previously read terms can also be used to indicate mental fatigue.

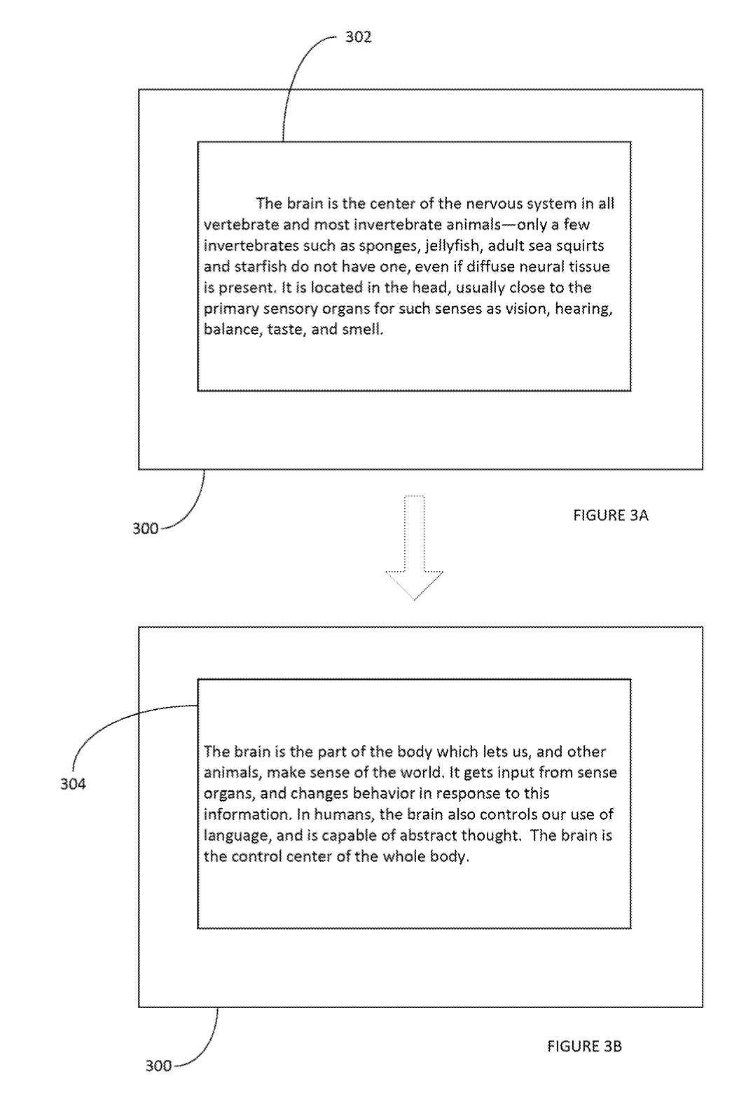

In step 104, the user is provided reading material at an optimum reading level. The optimum reading level can be determined according to various user attributes such as demographic profile, age, content being read, current user activity and/or reading level (e.g. as determined from historic testing data, eye-tracking data that indicated comprehension difficulty with respect to various terms that indicate a user's reading level, etc.). For example, a user may do a search for the term ‘brain’ in an online encyclopedia (e.g. Wikipedia). The user may be initially provided with an article as shown by element 302 of FIG. 3A (see infra). In some embodiments, an initial set of substantially contemporary eye-tracking data may have been obtained (e.g. during a user input of a search term) (e.g. step 106, see infra, can be performed). Eye-tracking data that indicates a mental fatigue level may be parsed from the eye-tracking data and matched to an averaged mental fatigue values (e.g. for a general population, for a population of similar demographic attributes to the user, to a historical user profile, and the like). In this way, the reading level of the initial content of the user may be set according to the user's current mental fatigue state.

In step 106, a user's current saccadic velocity can be determined. This value can be an averaged value of saccadic velocity over a period of time. It is noted that other eye-tracking attributes that are indicative of mental fatigue (e.g. pupil dilation, blink rates, blink periods, and the like) can be determined in lieu of and/or in addition to saccadic velocity. In step 108, a user's current reading level can be modified (e.g. increased, decreased) according to a mental fatigue level indicated by the data obtained in step 106. For example, a table can be provided that matches saccades velocity values to reading levels for a particular user. In another example, multiple eye-tracking attributes indicative of mental fatigue can be weighted and/or averaged together to determine a mental fatigue score. This score can be matched with various reading levels in a table. For example, a low-level of detected mental fatigue can be matched with a user's highest known reading level (e.g. a 12^{th} grade reading level). A high-level of detected mental fatigue can be matched with one or more reading levels below the optimum reading level (e.g. a 10^{th} grade reading level). In this way, the vocabulary or other attributes of reading content can be modified (e.g. switched with ‘easier’ to understand terminology, simpler test questions, lower level math problems can replace original aspects of the engaged content). In some embodiments, display attributes of the reading content can be modified to compensate for mental fatigue attributes. For example, when a higher than normal level of mental fatigue is detected for a user, the size of text of the content can be increased, display contrast can be modified to make the text easier to view, audio volume can be increased, audio replay can be slowed, etc. In one example, when a higher than normal level of mental fatigue is detected for a user, time allotted to complete certain tasks (e.g. flash card display periods, multiple choice questions times, practice exam periods, etc.) can be modified based on mental fatigue levels as indicated by eye-tracking data. For example, a user's saccadic velocity can be at a historical maximum indicating a lower than average mental fatigue level. The user may be taking a practice GMAT exam. Various levels of the practice exam can be modified based on the user's substantially current mental fatigue state. For example, more difficult practice questions can be provided to the user. Time allotted to answer questions and/or complete sections of the practice exam can be decreased. After a period of time, the user's eye-tracking data can indicate that the user's mental fatigue level is increasing (e.g. average saccadic velocity decrease). Various levels of the practice exam can again be modified based on the user's substantially current mental fatigue state. For example, less difficult practice questions can be provided to the user. Time allotted to answer questions and/or complete sections of the practice exam can be increased. Text size can be increased. Text can be highlighted. Text can be provided with audio output.

In another example, it can be determined if a saccadic velocity (and/or other eye behavior's that indicate mental fatigue) for a user indicates increased mental fatigue during a session. A session can be a specific period of time such as the user's work shift, reading session associated with a specified e-book or time on a task that involves reading or otherwise measurements by and eye tracking system (e.g. a medical task such as surgery, repair of a mechanical system, etc.), last hour of reading, time since the user last took a work break, time-on-duty, etc. Task complexity can be taken into account when setting mental fatigue thresholds. For example, various weighting factors can be assigned to certain tasks (e.g. reading a high-level medical test result, operating large machinery, etc. can be assigned higher task complexity). The acceptable mental fatigue indicator values for a user can be adjusted by these weighting factors. Thus, a user engaging in a task with greater task complexity can be assigned a lower set of eye behavior values that may indicate a mental fatigued state (e.g. thresholds for microsaccadic and saccadic peak velocity-magnitude relationship slopes can be adjusted accordingly).

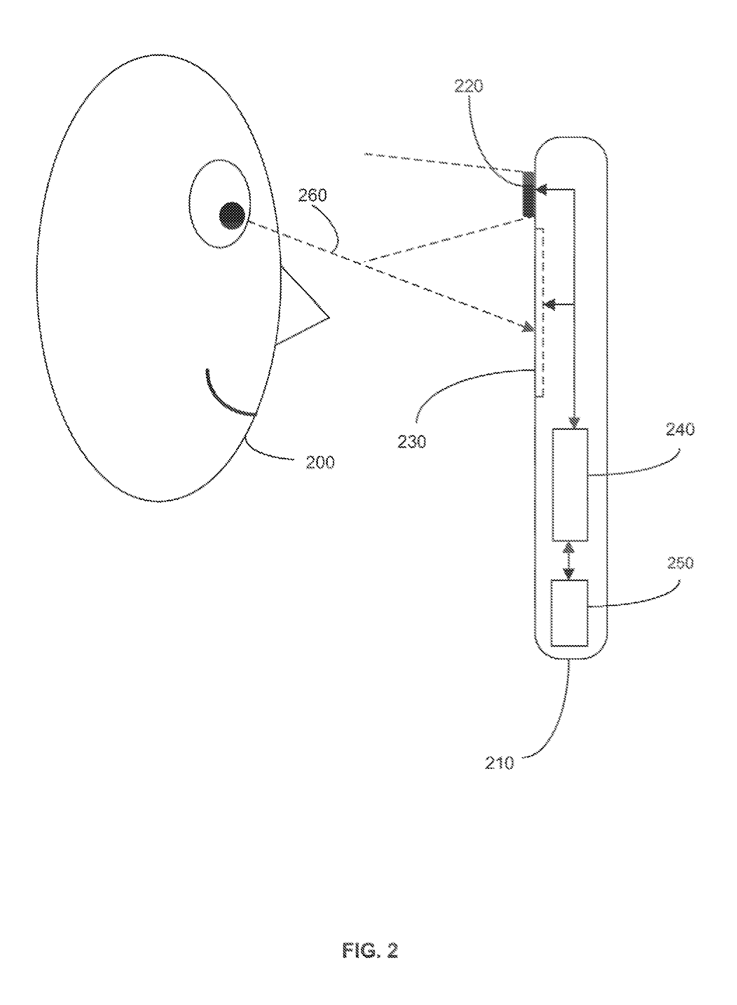

FIG. 2 illustrates one example of obtaining eye-tracking data from a user viewing a digital document (and/or a physical document). In this embodiment, eye-tracking module 240 of user device 210 tracks the gaze 260 of user 200. Although illustrated here as a generic user device 210, the device may be a cellular telephone (e.g. a smart phone), personal digital assistant, tablet computer (such as an iPad®), laptop computer, desktop computer, or the like. Eye-tracking module 240 may utilize information from at least one digital camera 220 and/or an accelerometer 250 (or similar device, such as a gyroscope, that provides positional information of user device 210) to track the user's gaze 260. Eye-tracking module 240 may map eye-tracking data to information presented on display 230. For example, coordinates of display information may be obtained from a graphical user interface (GUI). Various eye-tracking algorithms and methodologies (such as those described herein) may be utilized to implement the example shown in FIG. 2. In some examples, an eye-tracking system can be coupled with user device 210.

In some embodiments, eye-tracking module 240 may utilize an eye-tracking method to acquire the eye movement pattern. In one embodiment, an example eye-tracking method may include an analytical gaze estimation algorithm that employs the estimation of the visual direction directly from selected eye features such as irises, eye corners, eyelids, or the like to compute a gaze 260 direction. If the positions of any two points of the nodal point, the fovea, the eyeball center or the pupil center can be estimated, the visual direction may be determined.

In addition, a light may be included on the front side of user device 210 to assist detection of any points hidden in the eyeball. Moreover, the eyeball center may be estimated from other viewable facial features indirectly. In one embodiment, the method may model an eyeball as a sphere and hold the distances from the eyeball center to the two eye corners to be a known constant. For example, the distance may be fixed to 13 mm. The eye corners may be located (for example, by using a binocular stereo system) and used to determine the eyeball center. In one exemplary embodiment, the iris boundaries may be modeled as circles in the image using a Hough transformation. The center of the circular iris boundary may then be used as the pupil center.

In other embodiments, a high-resolution camera and other image processing tools may be used to detect the pupil. It should be noted that, in some embodiments, eye-tracking module 240 may utilize one or more eye-tracking methods in combination. Other exemplary eye-tracking methods include: a 2D eye-tracking algorithm using a single camera and Purkinje image, a real-time eye-tracking algorithm with head movement compensation, a real-time implementation of a method to estimate gaze 260 direction using stereo vision, a free head motion remote eyes (REGT) technique, or the like. Additionally, any combination of any of these methods may be used.

FIG. 3A depicts an example a reading material 302 of a certain reading level that has been provided to a user via a display 300 of a computing device, according to some embodiments. While the user is reading material 302, the user's eye-tracking data (e.g. saccadic information, gaze trace, etc.) can be obtained. Process 100 can be implemented. Accordingly, it can be determined that the user's current saccadic attributes (e.g. average saccadic velocity) can be below a specified threshold. Accordingly, the reading material 302 can be modified. For example, another reading material 304 can replace reading material 302 as provided in FIG. 3B. In one example, reading material 304 can be at an easier reading level than reading material 302. In another example, reading material 304 can be in a larger font or the font can be adjusted (e.g. more bold text, increased contrast, and the like). Thus, in some examples, the display of information and/or the content of the information provided can be modified according to a user's particular mental state (e.g. increased level of mental fatigue).

In one example, a specified number of user comprehension difficulties with respect to terms and/or phrases are detected in a specified density (e.g. one comprehension difficulty per twenty words, one comprehension difficulty per ten words, etc.) of a text. The text may be modified according to the various examples of FIGS. 3 A-B (and/or other examples provided herein). For example, the reading level of the text can be adjusted to an easier reading level. In yet another example, if the density of comprehension difficulties per terms is not detected, the read level of the text can be increased (and/or otherwise modified).

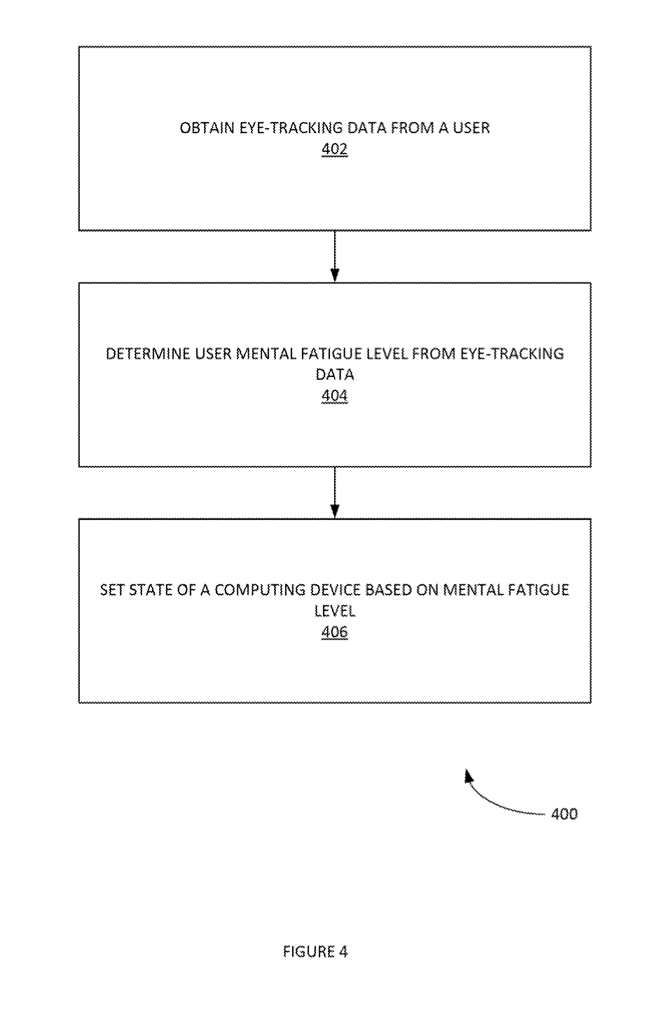

FIG. 4 depicts an example process 400 for setting a state of a computing device based on a mental attribute of a user (e.g. mental fatigue) as determined from eye-tracking data, according to some embodiments. Although, the attribute of mental fatigue is used as an example in process 400, other attributes can be detected and utilized as well. For example, eye-tracking data can be obtained from a user and compared with the user's historical eye-tracking data for similar types of text and/or images. This eye-tracking data can indicate that the user is not in a mentally fatigued state. The state of a computing device (e.g. display options, reading level of content, speed of application response, increase in device's screen lighting, etc.) can be set accordingly.

In step 402 of process 400, eye-tracking data may be obtained from a user. In step 404, a user's mental fatigue level can be determined from the eye-tracking data. In step 406, a state of a computing device can be set according to the user's mental fatigue state.

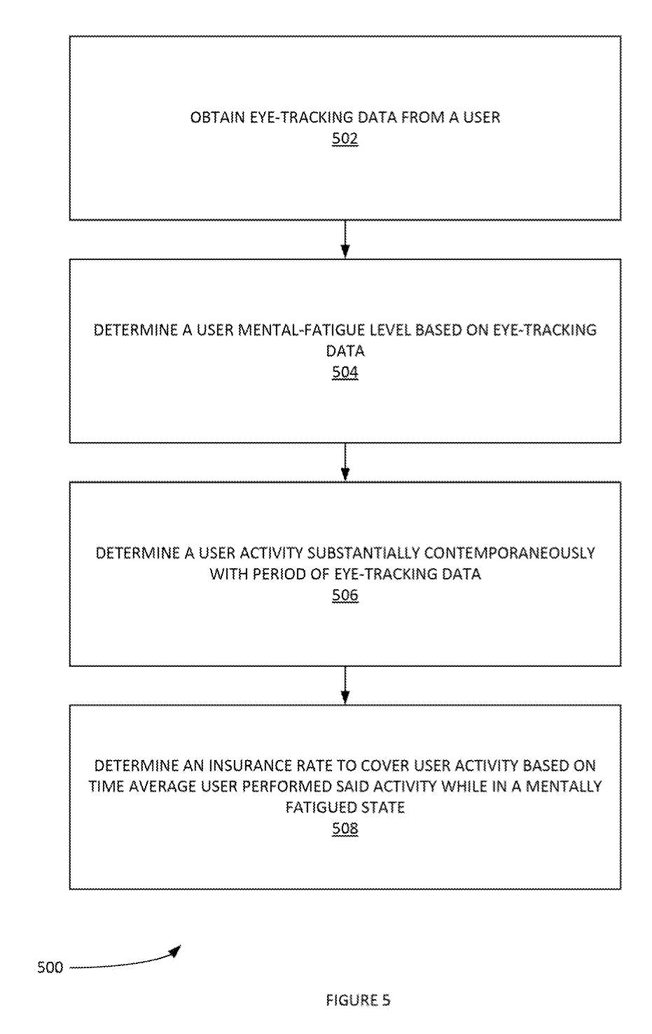

FIG. 5 depicts an example process 500 for determining an insurance rate for a particular activity based on user eye-tracking data, according to some embodiments. In some embodiments, the eye-tracking data can be a historical average of various selected eye-tracking data components (e.g. average saccadic velocity, average time spent reading a label for one or more users, average number of times a user is distracted in a specified period, etc.). For example, a pharmacy malpractice insurer can obtain eye-tracking data for a pharmacist (or other pharmacy professional) with respect to each prescription verification the pharmacist performs. The eye-tracking data can be used to determine that the pharmacist adequately reviews the incoming prescription, the label of the pill container, the customer's information, and/or other safeguards. A pharmacist can be scored for each prescription filled based on the received eye-tracking data. The scores can be aggregated for the pharmacist and/or any other employees of the pharmacy. This score can be used to determine a malpractice rate for the pharmacy. Similar systems can be implemented for automobile drivers, long-haul truckers, airplane pilots, automobile and/or aircraft mechanics and the like. Other practitioner states (e.g. average time practitioner is mentally fatigued during a process) that can be inferred from eye-tracking data can be determined and scored as well. Various scores can be aggregated and/or used to weigh another score. For example, a practitioner's mental fatigue score (e.g. as determined by a differential between current saccadic velocity and a historically average and/or optimum (e.g. as measured when well rested) saccadic velocity) can be used to weigh a period of time the practitioner was visually focused on a required element of a task (e.g. reading a prescription label, reviewing a repair element, reading a patient's information, etc.). In this way, a mentally-fatigued practitioner may receive a lower score unless she spends additional time reviewing the task element.

Returning now to process 500, in step 502, eye-tracking data can be obtained for a user. In step 502, a user fatigue level for the user can be determined. In step 504, a user's mental-fatigue level (and/or other mental state) can be inferred from eye-tracking data. In step 506, a user's activity that is performed substantially contemporaneously with the eye-tracking data acquisition is determined. In step 508, an insurance rate (e.g. a premium) to insure the user activity is determined. The insurance rate can be based on a timed average the user performed said activity in a mentally fatigued state. In one embodiment, the insurance rates can vary as a function of time and as a function of a user's current mental fatigue level (e.g. as indicated by eye-tracking data).

In one example, an eye-tracking system can monitor a medical professional (e.g. a pharmacist, a doctor, a nurse, a dentist and the like) while the medical professional reads information related to patient care (e.g. a lab report, a prescription, an x-ray, etc.). The eye-tracking data can be monitored to determine a mental state (e.g. according to saccadic velocity differentials (e.g. as between current and historical averages), blink rates and velocities, etc.) of the medical professional. For example, the medical professional's saccadic velocity can be currently be below a normal historical average for the particular medical professional. It can be determined that the content of the medical record may not be more difficult and/or substantial differ from past records regularly read by the medical professional. In this way, it can be determined that the medical professional is in a substantially current mentally fatigued state. A notice can be provided to an administrator with oversight of the medical professional. Various additional steps can be added to the workflow of related to the patient and/or patient's medical treatment (e.g. a drug prescription can be double checked, a surgeons worked can be double checked, a radiologist's conclusion can be double checked, etc.) if it is determined that a medical professional is in a mentally fatigued stated. Similar procedures can be implemented for airline pilots, truckers, computer programmers, etc.

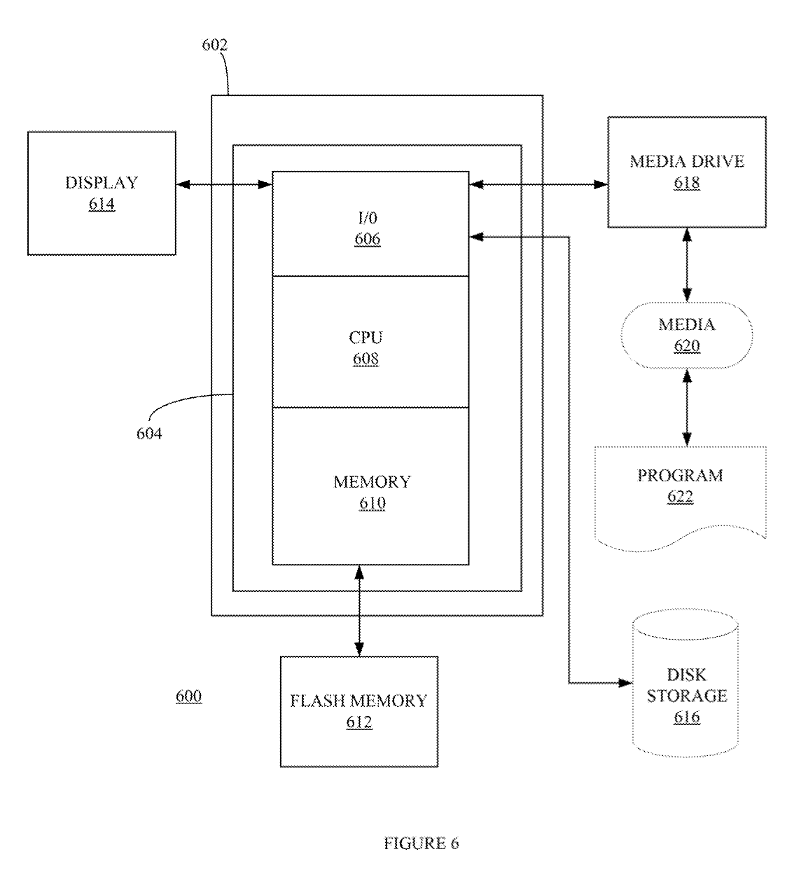

FIG. 6 depicts an exemplary computing system 600 that can be configured to perform any one of the processes provided herein. In this context, computing system 600 can include, for example, a processor, memory, storage, and I/O devices (e.g., monitor, keyboard, disk drive, Internet connection, etc.). However, computing system 600 can include circuitry or other specialized hardware for carrying out some or all aspects of the processes. In some operational settings, computing system 600 can be configured as a system that includes one or more units, each of which is configured to carry out some aspects of the processes either in software, hardware, or some combination thereof.

FIG. 6 depicts a computing system 600 with a number of components that can be used to perform any of the processes described herein. The main system 602 includes a motherboard 604 having an I/O section 606, one or more central processing units (CPU) 608, and a memory section 610, which can have a flash memory card 612 related to it. The I/O section 606 can be connected to a display 614, a keyboard and/or other attendee input (not shown), a disk storage unit 616, and a media drive unit 618. The media drive unit 618 can read/write a computer-readable medium 620, which can include programs 622 and/or data. Computing system 600 can include a web browser. Moreover, it is noted that computing system 600 can be configured to include additional systems in order to fulfill various functionalities. Display 614 can include a touch-screen system and/or sensors for obtaining contact-patch attributes from a touch event. In some embodiments, system 600 can be included and/or be utilized by the various systems and/or methods described herein.

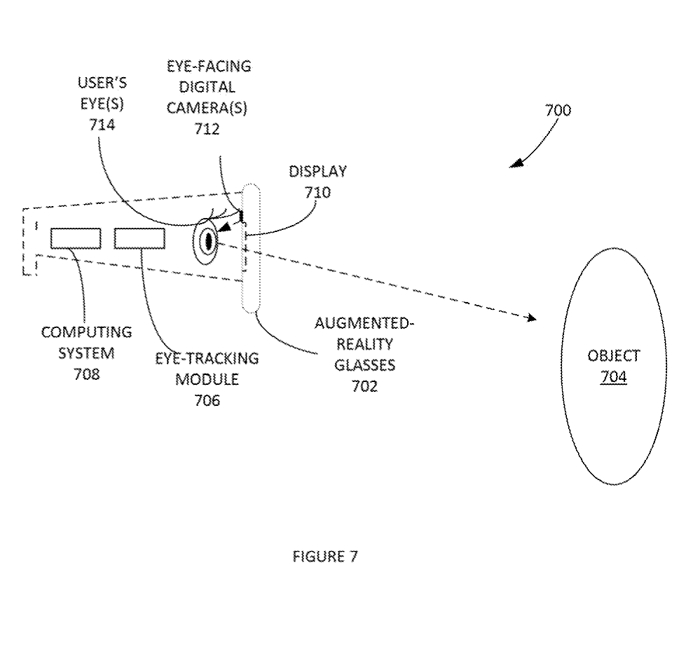

FIG. 7 illustrates a side view an augmented-reality glasses 702 in an example embodiment. Although this example embodiment is provided in an eyeglasses format, it will be understood that wearable systems may take other forms, such as hats, goggles, masks, headbands and helmets. Augmented-reality glasses 702 may include an optical head mounted display (OHMD). Extending side arms may be affixed to the lens frame. Extending side arms may be attached to a center frame support and lens frame. Each of the frame elements and the extending side-arm may be formed of a solid structure of plastic or metal, or may be formed of a hollow structure of similar material so as to allow wiring and component interconnects to be internally routed through the augmented-reality glasses 702.

A lens display may include lens elements that may be at least partially transparent so as to allow the wearer to look through lens elements. In particular, a user's eye(s) 714 of the wearer may look through a lens that may include display 710. One or both lenses may include a display. Display 710 may be included in the augmented-reality glasses 702 optical systems. In one example, the optical systems may be positioned in front of the lenses, respectively. Augmented-reality glasses 702 may include various elements such as a computing system 708, user input device(s) such as a touchpad, a microphone, and a button. Augmented-reality glasses 702 may include and/or be communicatively coupled with other biosensors (e.g. with NFC, Bluetooth®, etc.). The computing system 708 may manage the augmented reality operations, as well as digital image and video acquisition operations. Computing system 708 may include a client for interacting with a remote server (e.g. augmented-reality (AR) messaging service, other text messaging service, image/video editing service, etc.) in order to send user bioresponse data (e.g. eye-tracking data, other biosensor data) and/or camera data and/or to receive information about aggregated eye tracking/bioresponse data (e.g., AR messages, and other data). For example, computing system 708 may use data from, among other sources, various sensors and cameras (e.g. outward facing camera that obtain digital images of object 704) to determine a displayed image that may be displayed to the wearer. Computing system 708 may communicate with a network such as a cellular network, local area network and/or the Internet. Computing system 708 may support an operating system such as the Android™ and/or Linux operating system. Computing system 708 can perform speech to text operations (e.g. with a speech recognition functionality) and/or provide receive voice files to a server for speech to text operations. Text derived from said speech to text can be displayed to a user and/or be input into other functionalities (e.g. a text messaging application, a real-estate related application, annotate images of real estate, etc.).

The optical systems may be attached to the augmented reality glasses 702 using support mounts. Furthermore, the optical systems may be integrated partially or completely into the lens elements. The wearer of augmented-reality glasses 702 may simultaneously observe from display 710 a real-world image with an overlaid displayed image. Augmented reality glasses 702 may also include eye-tracking system(s) that may be integrated into the display 710 of each lens. Eye-tracking system(s) may include eye-tracking module 708 to manage eye-tracking operations, as well as, other hardware devices such as one or more a user-facing cameras and/or infrared light source(s). In one example, an infrared light source or sources integrated into the eye-tracking system may illuminate the eye(s) 714 of the wearer, and a reflected infrared light may be collected with an infrared camera to track eye or eye-pupil movement.

Other user input devices, user output devices, wireless communication devices, sensors, and cameras may be reasonably included and/or communicatively coupled with augmented-reality glasses 702. In some embodiments, augmented-reality glass 702 may include a virtual retinal display (VRD). Computing system 708 can include spatial sensing sensors such as a gyroscope and/or an accelerometer to track direction user is facing and what angle her head is at.

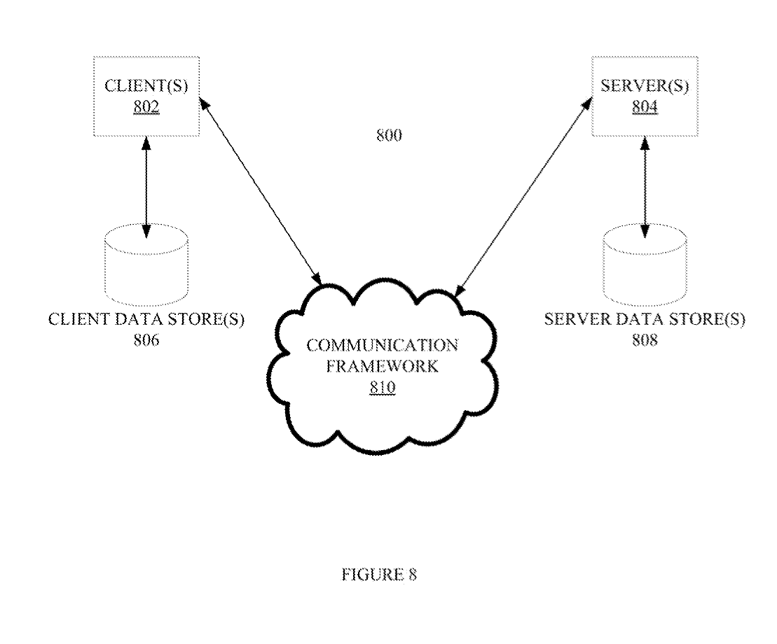

FIG. 8 is a block diagram of a sample computing environment 100 that can be utilized to implement various embodiments. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 810 that can be employed to facilitate communications between the client(s) 802 and the server(s) 804. The client(s) 802 are connected to one or more client data store(s) 806 that can be employed to store information local to the client(s) 802. Similarly, the server(s) 804 are connected to one or more server data store(s) 808 that can be employed to store information local to the server(s) 804.

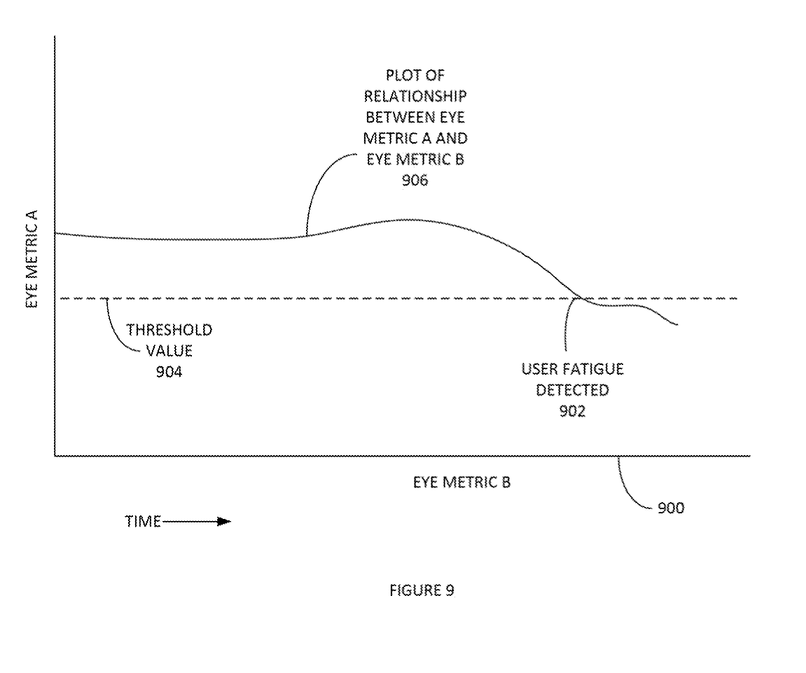

FIG. 9 illustrates an example plot 900 showing the relationship between two or more eye metrics used to determine a user mental fatigue state, according to some embodiments. The plot 906 can show the relationship between two or more eye metrics (e.g. eye metric A and eye metric B). The plot 906 can be in n-dimensions based on the number eye-metrics used in the plot. Eye metrics can be modified (e.g. normalized, transformed, etc.) before being plotted. A threshold value 904 for determining a user fatigue state can be set. In some examples, the threshold value can be dynamically modified based on certain factors (e.g. user state such as increase pulse rate, increased respiratory rates, increased blood pressure can be used to increase threshold; computing machine states; user task (e.g. increased for a riskier task, decreased for low risk tasks, increased for complex task with a specified liability associated with it, etc.). The eye metrics can be plotted as a function of time. When the plot 906 falls below threshold 904, it can be determined that the user is in a fatigued state 902. In some examples, the plot 906 may be determined to be below threshold 904 for a specified period before it is determined that the user is in a fatigued state. Falling below threshold 904 can trigger—repeat text until can verify user has read, text message another user to review user's task product, decrease rate of task, decrease rate of providing text to user, decrease complexity of task, provide augmented-reality message to user indicating mental fatigue level and/or request user review a particular portion of a task, etc. In one example, the system can replace a text of a particular reading level with a text about the same content but at a lower reading level (e.g. replace an English Wikipedia article with a simplified English Wikipedia article in a search result). Search results can be modified for a user based on a user's mental fatigue state. For example, a user indicating a mental fatigue state can search for a Wikipedia article on the ‘brain’. The simplified English article on the ‘brain’ can be scored higher than the Standard English Wikipedia article on the ‘brain’. In other examples, documents can be scored according to the complexity or difficulty of their content. Digital documents with scores indicating less complex content can ranked higher by an online search engine when the user performing the search indicates mental fatigue. In this way, search engine (e.g. a Web-based search engine) results can be personalized to a user's mental fatigue state. These examples can be incorporated with other methods of scoring search engine results. It is noted that the actual display of a plot model need not be performed (e.g. in one or more computer processors), rather, in some embodiments, the calculations and values involved can be determined without rendering a plot model for display on a user interface. In one example, an airplane pilot can wear a head-mounted computing device with an eye tracking system. A set of eye metrics obtained from the pilot can indicate a mental fatigued state. The head mounted computing device can then display various warning signs to the pilot (e.g. indicating mental fatigue state, double check certain flights operations and readings, etc.). The head mounted computing device can automatically message a co-pilot and/or a ground control system to indicate the pilot's current mental fatigue state. The airplanes pilot interface system can modify its displays (e.g. brighten dashboard lights, repeat certain readings, provide voice output, etc.) when it is determined that the pilot is in a mental fatigued state.

A decrease in the value of the relationship (e.g. linear and/or transformed valued) of the microsaccadic and saccadic peak velocity can indicate an increase in user mental fatigue. Other parameters (e.g. any combination of eye metrics such as saccadic metrics, user blink rate, pupil dilation, regressions, etc.) can be included in a relationship. For example, the relationship of these values can be graphed in n-dimensional plot. Measurements of metrics that can increase in value (e.g. blink rate, blink duration, measurements of ocular instability such as eye drift and tremor, regressions per word, regressions per second, etc.) with user mental fatigue can be modified to not offset metrics that decrease (e.g. saccadic velocity metric) in value with user mental fatigue (or vice versa). Modifications in the n-dimensional plot of these metrics (e.g. a decrease as a function of time) can be used to determine whether the user is in a mentally fatigued state. Each user can be assigned a threshold level(s) for a particular n-dimensional plot (e.g. in a linear regression model). The mental fatigue state can be achieved when a specified number of points of the plot are detected below the threshold. The detection of a mental fatigue state can be used to trigger computer system states and/or scores that affect such user attributes as test practice materials to provide to the user, user insurance rates, and the like. It is noted that the selection of eye metrics can be varied based on the identity of the user task and/or user (e.g. the blink rate metric can be removed from determine mental fatigue of a user with a high initial blink rate).

Text with higher levels of readability can be selected and provided (e.g. substituted for) text with lower levels of readability when it is determined that a user's eye metrics indicate a mental fatigued state. Web-page documents with higher levels of readability can be scored higher in response to search queries when it is determined that a user's eye metrics indicate a mental fatigued state. Examples of methods used to determine readability of a text include, inter alia: Accelerated Reader, Automated Readability Index, Coleman-Liau Index, Dale-Chall Readability Formula, Flesch-Kincaid readability tests (e.g. Flesch Reading Ease, Flesch-Kincaid Grade Level), Fry Readability Formula, Gunning-Fog Index, Lexile Framework for Reading, Linsear Write, LIX, Raygor Estimate Graph, SMOG (Simple Measure Of Gobbledygook), Spache Readability Formula, and the like. A readability test can include a formulae for evaluating the readability of text, usually by counting syllables, words, and sentences. A search engine functionality can obtained a web-page document's readability from application of one or more methods of determining readability of the content of the web page document and/or obtain relevant metadata about the web-page document. In some examples, web page documents (e.g. advertisement documents) relating to vacations, relaxation content, massages, games, recreational activities can be scored higher in a search engine query result when it is determined that a user's eye metrics indicate a mental fatigued state. In some examples, a user's reading grade level can be obtained and used to determine an appropriate readability level of digital document content.

Any information obtained from the processes and systems provided supra can be used to determine various insurance premiums in the relevant fields of activity. For example, a risk probability can be determined for an activity performed by a user while the user is in a mentally fatigued state. This risk can used to determine and/or modify an insurance premium (e.g. on a task by task basis). It is noted that modifications to text presentation and/or text content can be reversed when the user's eye metric increase about the threshold at a later time.

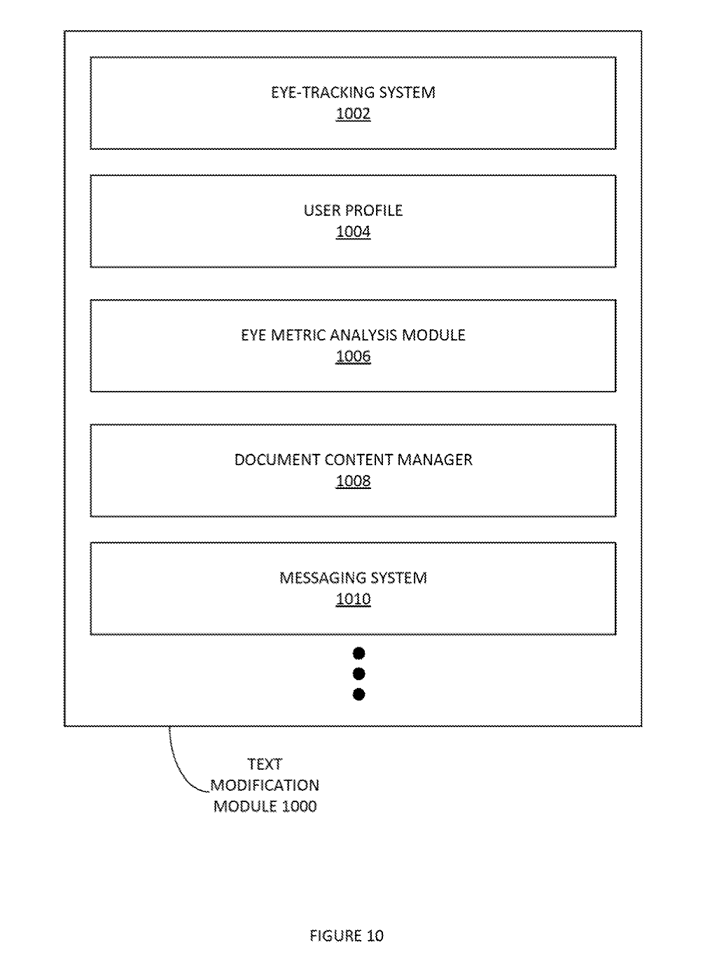

FIG. 10 depicts, in block diagram format, an example of a text modification module 1000, according to some embodiments. Text modification module 1000 can be used to modify text presentation and/or text content based on a current user mental fatigue state. For example, eye-tracking system 1002 can obtain user eye metrics (such as those discussed supra). User profile module 1004 can include various information about a particular user such as the various thresholds for eye metrics that indicate mental fatigue in the user. Other data can include a list of user tasks, data for image recognition of user tasks (e.g. as obtained by an outfacing camera of a pair of smart glasses), user profile information, user age and other demographic information, etc. Thresholds for a particular eye metric data can be based on user profile information, task activity, computer device state, etc.

User eye metrics can be analyzed by the eye metric analysis module 406. Eye metric analysis module 406 model various eye metric and determine when eye metrics fall below a specified threshold. Examples have been provided supra. For example, user eye metrics that indicate the user mental fatigue state can include a regression analysis of the saccadic peak velocity-magnitude relationship. A plot of the regression analysis of the saccadic peak velocity-magnitude relationship declines below a specified threshold value. In another example, user eye metrics that indicate the user mental fatigue state can include a regression analysis of a relationship of the saccadic peak velocity, a user blink attribute, and a measurement of an ocular instability of the user. The value of the regression analysis of the relationship of the saccadic peak velocity, a user blink attribute, and the measurement of the ocular instability of the user can decline below a specified threshold value and indicate user mental fatigue. In some examples, the specified threshold can be a five percent (5%) decrease in an eye metric or a value of a relation of a set of eye metrics. In some examples, the specified threshold can be a three percent (3%) decrease in an eye metric or a value of a relation of a set of eye metrics. In some examples, the specified threshold can be a ten percent (10%) decrease in an eye metric or a value of a relation of a set of eye metrics. In some examples, the specified threshold can be a twenty-five percent (25%) decrease in an eye metric or a value of a relation of a set of eye metrics. These specified threshold are provided by way of example.

Document content manager 1008 can modify content (e.g. modify text presentation, modify text content, modify search result content, etc.). Messaging system 1010 can communicate information (e.g. user mental fatigue state, eye metrics, text content, etc.) to other users, to administrative entities, to web servers, etc. Other functionalities in text modification module 1000 can include search engines, image recognition functionalities and text-to-voice functionalities.

At least some values based on the results of the above-described processes can be saved for subsequent use. Additionally, a (e.g. non-transients) computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML). Any information obtained from the processes and systems provided supra can be used to determine various insurance premiums in the relevant fields of activity.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-10 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A method comprising:
obtaining, with an eye-tracking system, one or more user eye metrics, while the user is reading a text content;
determining that the one or more user eye metrics indicate a user mental fatigue state based on the one or more user eye metrics; and
modifying an attribute of the text content.

2. The method of claim 1, wherein modifying an attribute of the text content further comprises:
increasing a font size of the text content.

3. The method of claim 1, wherein modifying an attribute of the text content further comprises:
repeating a display of the text content to the user.

4. The method of claim 1, wherein modifying an attribute of the text content further comprises:
highlighting a portion of the text content.

5. The method of claim 1, wherein modifying an attribute of the text content further comprises:
replacing the text content to include another text content, wherein the other text content is of a lower reading difficulty level than the text content.

6. The method of claim 1, wherein the text content comprises at least one of a digital display of a pharmaceutical drug label, a laboratory report, a vehicle dashboard, a medical prescription, an accounting document, a legal document or a patient's medical record.

7. The method of claim 1 further comprising:
communicating a messaging describe that the user mental fatigue state and the text content to another computing system.

8. The method of claim 1 further comprising:
providing an audio warning of the user mental fatigue state.

9. The method of claim 1, wherein the one or more user eye metrics that indicate the user mental fatigue state comprises a decrease in a saccadic peak velocity during a task.

10. The method of claim 1,
wherein the one or more user eye metrics that indicate the user mental fatigue state comprises a regression analysis of the saccadic peak velocity-magnitude relationship; and
wherein the plot of the regression analysis of the saccadic peak velocity-magnitude relationship declines below a specified threshold value.

11. The method of claim 1,
wherein the one or more user eye metrics that indicate the user mental fatigue state comprises a regression analysis of a relationship of the saccadic peak velocity, a user blink attribute, and a measurement of an ocular instability of the user, and
wherein the value of the regression analysis of the relationship of the saccadic peak velocity, a user blink attribute, and the measurement of the ocular instability of the user declines below a specified threshold value.

12. A computerized system comprising:
a processor configured to execute instructions;
a memory containing instructions when executed on the processor, causes the processor to perform operations that:
obtain, with an eye-tracking system, one or more user eye metrics, while the user is reading a text content;
determine that the one or more user eye metrics indicate a user mental fatigue state based on the one or more user eye metrics; and
modify an attribute of the text content.

13. The computerized system of claim 12, wherein the memory containing instructions when executed on the processor, causes the processor to perform operations that modifying an attribute of the text content by increasing the size of the text font.

14. The computerized system of claim 12, wherein the memory containing instructions when executed on the processor, causes the processor to perform operations that modifying an attribute of the text content by repeating a display of the text content to the user.

15. The computerized system of claim 12, wherein the memory containing instructions when executed on the processor, causes the processor to perform operations that modifying an attribute of the text content by replacing the text content to include another text content, wherein the other text content is of a lower reading difficulty level than the text content.

16. The computerized system of claim 12, wherein the one or more user eye metrics that indicate the user mental fatigue state comprises a decrease in a saccadic peak velocity during a specified time on task.

17. The computerized system of claim 12,
wherein the one or more user eye metrics that indicate the user mental fatigue state comprises a regression analysis of a relationship of the saccadic peak velocity, a user blink attribute, a regression rate, and a measurement of an ocular instability of the user, and
wherein the value of the regression analysis of the relationship of the saccadic peak velocity, a user blink attribute, the regression rate and the measurement of the ocular instability of the user declines below a specified threshold value.
